(19) United States
(12) Patent Application Publication
(10) Pub. No.: US 2006/0022105 A1
(43) Pub. Date: Feb. 2, 2006

(54) Bracket and hanger assembly

(76) Inventor: Iain N.B. MacKay, Beeton (CA)

Correspondence Address: PERLEY-ROBERTSON, HILL & MCDOUGALL LLP, 90 SPARKS STREET, 4TH FLOOR, OTTAWA, ON, K1P1E2, CA

(21) Appl. No.: 10/900,125

(22) Filed: Jul. 28, 2004

(51) Int. Cl. F16B 45/00

(52) U.S. Cl. 248/304

(57) ABSTRACT

A novel bracket and hanger assembly which is designed for attachment to the sidewalls of an elongate support which is rectangular in cross-section is disclosed. The bracket is either an L-shaped member having two limb sections or an U-shaped member having three limb sections. Each of the limb sections has an aperture extending therethrough and an interior face engageable with one of the sidewalls of the elongate support. The hanger has an elongate hook and an enlarged end portion. The hook is passed through an aperture from the interior face of the limb section until the enlarged end portion abuts a surface area surrounding the aperture. The assembly is further characterized by means for maintaining the hanger in a selected rotational position relative to a limb section through which it extends when the enlarged end portion of the hanger abuts the surface area surrounding the aperture. This permits the assembly to be attached to inclined beams or vertical supports whilst permitting the hook to take up a desired rotational position to the limb section through which it extends.

### BACKGROUND OF THE INVENTION

This invention relates to a novel bracket and hanger assembly which is intended to be attached to the sidewalls of an elongate support which is rectangular in cross-section, such as a wooden stud, joist or rafter, inclined beam or truss.

In its simplest form, a nail can be driven into a wooden member in order to function as a hook for all manner of items. Hooks which at one end include threads for screwing the hook into wood are also well known in the art. However, many hooks having a threaded end portion are of such a size that they can not be conveniently turned or screwed into a member where turning space is at a premium, such as in the case where the side of a vertical stud has attached to it an exterior wall. Further, hangers which are attached to a flat face of a support by means of one or more screws or nails, such as to a sidewall of a stud, are subject to pulling off from the face to which they are attached if excessive weight is applied to them.

### SUMMARY OF THE INVENTION

The novel bracket and hanger assembly of this invention can be attached to the sidewalls of any elongate support which is rectangular in cross-section. The hanger itself can be rotated and fixed in a selected rotational position relative to the bracket to which it is attached. Further, one type of L-shaped mounting bracket can be used in combination with one or two separate hangers whereas a U-shaped mounting bracket can be used in combination with one, two or three hangers as desired or as may be dictated by free space considerations for hanging various objects.

The bracket portion of the assembly of this invention comprises either a L-shaped member having two limb sections or a U-shaped member having three limb sections. All of the limb sections have an aperture extending therethrough and an interior face engageable with sidewalls of the support member. Accordingly, the interior faces of the L-shaped member are engageable with two adjacent sidewalls of the elongate support, whereas the three interior faces of the U-shaped member are engageable with three sidewalls of the elongate support.

Each hanger comprises an elongate hook and an enlarged end portion whereby the hook is capable of being passed through the aperture in each limb section from its interior face until the enlarged end portion of the hanger engages a surface area on the interior face surrounding each of the apertures.

Means is also provided for maintaining the hanger in a selected rotational position relative to the aperture through which it extends when its enlarged end portion is in engagement with the surface area that surrounds the aperture. This latter feature effectively enables the hanger to be rotated and then held in a fixed or “clocked” position relative to the limb section of the bracket through which it extends. The “clocking” of the hanger relative to its associated limb section of the bracket is important where say, the central portion of a U-shaped bracket is located on the top or bottom of a horizontal support member, since the hanger and more particularly its hook end may have to be rotated 180°. Clocking of the hanger is relative to its limb section is also necessary where the support member to which the L-shaped or U-shaped bracket is attached is inclined, say at a 45° angle.

In accordance with one embodiment of this invention, the apertures in each of the limb sections can be triangular, square or star-shaped so as to rotationally interlock with a base section on the hook adjacent to its enlarged end portion. It will thus be apparent, for example, that if a star-shaped aperture has eight points and the base section located on the hook portion adjacent the enlarged end portion has four points, or in other words is square in cross-section, the hanger can be rotated and locked relative to the limb section of the bracket through which it extends in forty-five degree increments, or a total of eight different positions relative to its limb section.

Advantageously, the enlarged end portion of the hanger can be relatively thin so that when the hanger itself is located in its desired rotational or clocked position, it is held in its locked location, since the trailing or exterior face of the enlarged end portion itself together with its associated interior face of the limb section is in engagement with a common sidewall of the elongate support member to which the bracket is or will be attached.

In accordance with yet another embodiment of this invention, the surface area about each aperture on the interior face of each limb section can itself be indented so as to receive within the indent the enlarged end portion of the hanger. In this configuration, it will be evident that the trailing or exterior face of the enlarged end portion of the hanger received within the indent, is effectively flush with the remainder of the interior face of the limb section through which the hanger extends.

In accordance another aspect of this invention, the perimeter of each indent can have a shape such as a triangle, square or star so as to receive therein and lockingly engage with at least a portion of the perimeter of the large end portion which is received within the indent. In this particular configuration, if the hook portion of the hanger is circular in cross-section, the apertures can be similarly circular in cross-section since the clocking of the hanger relative to its bracket is dictated by the selective locking engagement of the periphery of the enlarged end portion of the hanger with the periphery of the indent.

A further advantage inherent is the novel bracket and hanger assembly of this invention is its ability to be physically attached to two or the three sides of an elongate support member which is rectangular in cross-section, thus imparting to it a far superior connection between the bracket and its support, compared to hangers that are intended to be attached to only one face or sidewall of a support.

### BRIEF DESCRIPTION OF THE DRAWINGS

In the accompanying drawings which illustrate different embodiments of my novel bracket and hanger assembly:

FIG. 1 is a perspective view of a U-shaped bracket component having a star shaped aperture in each of its three limb sections;

FIG. 2 is a perspective view of a representative hanger as may be used with the bracket of FIG. 1;

FIG. 3 is a view of a U-shaped bracket and hanger assembly as seen from one side and illustrating eight clocking positions of one hanger relative to the limb section of the bracket through which it extends;

FIG. 4 is a perspective view of a assembly of this invention attached to an inclined roof beam;

FIG. 5 is a perspective view of a L-shaped bracket having star shaped indents in the interior faces of the limb section and located in the surface area surrounding the apertures, and

FIG. 6 is a perspective view of a hanger having a square shaped enlarged end portion and intended for clocking and interlocking use with brackets having indents as shown in FIG. 5.

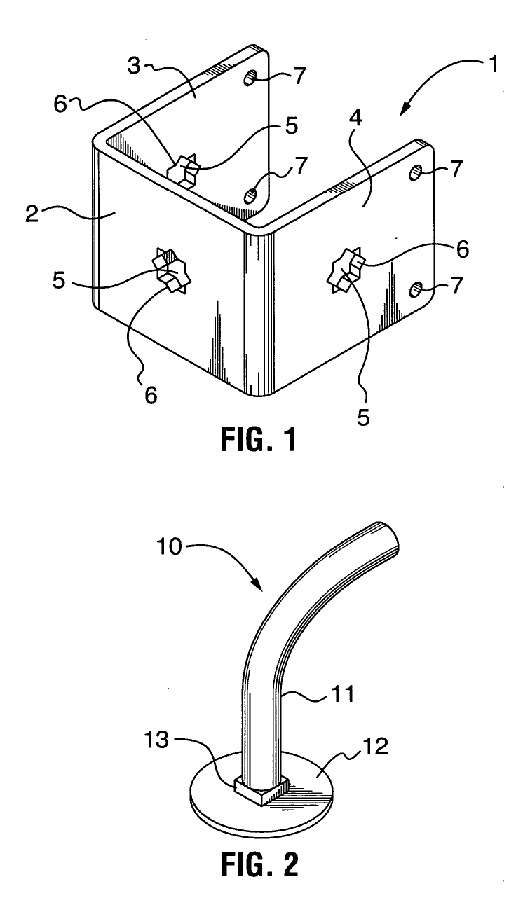

Referring firstly to FIGS. 1 through 4, U-shaped bracket 1 is provided with a central limb section 2 and two side limb sections 3 and 4 disposed at right angles thereto and which are dimensioned so that the interior faces of the limb sections engage three side faces of an elongate support member which is rectangular in cross-section and as best seen in FIG. 4 with reference to elongate roof beam 30. Each limb section 2, 3, and 4 has extending therethrough, identically shaped apertures 5 provided with star-shaped sidewalls 6 and which, as illustrated have eight points each. Means for attaching the bracket to a support member, as shown, are in the form of nail holes 7 extending through side sections 3 and 4.

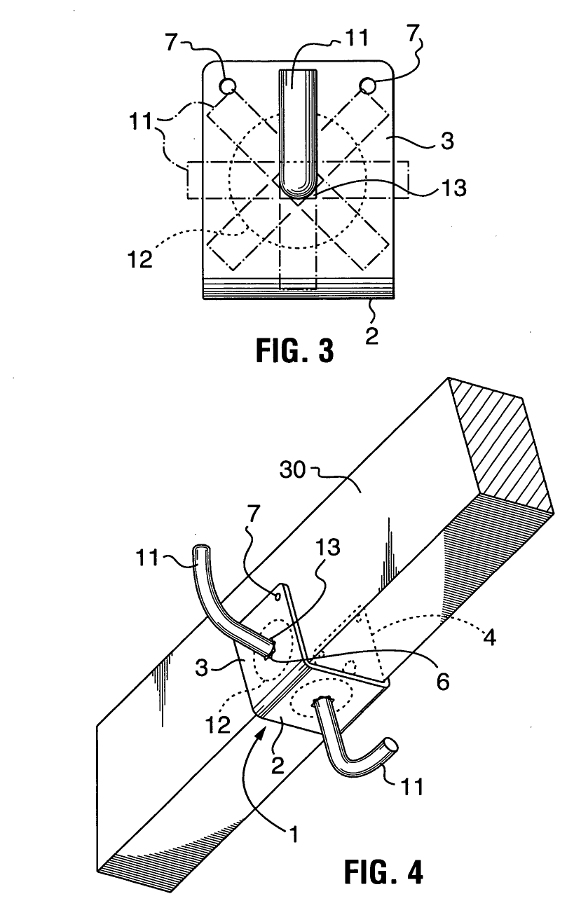

As seen in FIG. 2, the hanger component 10 comprises a elongate hook portion 11 and an enlarged end portion 12 which as illustrated, is disk-shaped. Located between hook portion 11 and enlarged end portion 12 is square shaped base section 13, the four corners of which are adapted to be received in and rotationally held or locked in a selected angular relationship to a limb section of bracket 1 as best seen in FIGS. 3 and 4. Because sidewalls 6 of each aperture 5 as illustrated are star-shaped and have eight points, when hook portion 11 is inserted through aperture 5 so that enlarged end portion 12 engages a surface area of the interior face of the limb section about the aperture, base section 13 can lockingly engage the aperture 5 in eight different possible positions as best illustrated with reference to FIG. 3.

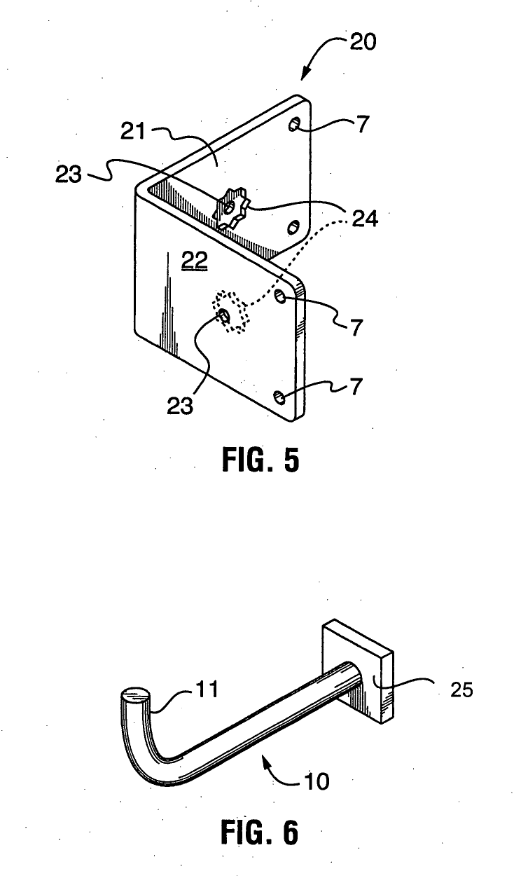

FIGS. 5 and 6 illustrate a different type of interlocking and clocking arrangement from that described in connection with FIGS. 1 through 4, and as illustrated, is shown in context of a L-shaped bracket which is intended to be attached two adjacent right-angled sidewalls of an elongate support member (not shown).

L-shaped bracket 20 is provided with two limb sections 21 and 22. As illustrated, apertures 23 in each limb section are circular in cross-section so as to permit elongate hook 11 of hanger 10 seen in FIG. 6 to pass therethrough in a manner previously discussed in connection with FIGS. 1-4. However, and unlike the hanger illustrated in FIG. 2, the hanger of FIG. 6 does not have a base section which is square in cross-section and its enlarged end portion is in the shape of a square 24 rather than the disc 12 seen in FIG. 2.

As illustrated, the interior faces of limb sections 21 and 22 about there respective apertures 23 are provided with a indent 24 which, as illustrated, has a perimeter which is in the shape of a eight pointed star. It will thus be apparent that when hook 11 of hanger 10 is passed through one of the apertures 23, its enlarged end portion 24 which is in the shape of a square as seen in FIG. 6 can be received within the indent 23 in eight different possible positions. This effectively means that, as illustrated, hanger 10 can be clocked in eight different positions relative to limb section 21 or 22 through which it extends.

It will also be appreciated that the L-shaped or U-shaped bracket component of this invention can be provided with an indent which has a circular periphery so as to receive therein an enlarged end portion of the bracket which is disc shaped. In this type of arrangement, when the hanger is in situ, the enlarged end portion of the hanger being relatively thin effectively lies flush with the remainder of the interior face of the limb section through which it extends, but there is no interlocking capability between the disc shaped enlarged end portion and the circular indent. It will be apparent, however, that interlocking of the hanger and bracket can be achieved even though the end portion is disc shaped and the indent is circular if interlocking means, such as that illustrated in FIGS. 1 through 4, are employed.

1. A bracket and hanger assembly for attachment to sidewalls of an elongate support which is rectangular in cross-section,
said bracket comprising one of an L-shaped member having two limb sections and a U-shaped member having three limb sections, each of said limb sections having an aperture extending therethrough and an interior face engageable with one of said sidewalls,
said hanger comprising an elongate hook having an enlarged end portion whereby said hook is capable of being passed through said apertures from the interior face of each of said limb sections until a first face of said enlarged end portion abuts a surface area surrounding said apertures,
said assembly being further characterized by means for maintaining said hanger in one of a number of one-selected rotational positions relative to one of said limb sections through which it is passed when an opposite face of said enlarged end portion abuts one of said sidewalls.

2. The assembly as claimed in claim 1, wherein said means for maintaining said hanger in a selected rotational position includes interlocking means on said hanger and each of said limb sections.

3. The assembly as claimed in claim 2, wherein said interlocking means includes outwardly directed projections on said hanger which are engageable with inwardly directed projections in each of said limb sections.

4. The assembly as claimed in claim 3, wherein said outwardly directed projections on said hanger include a base section adjacent said enlarged end portion which is square in cross-section, and said inwardly directed projections are located in said apertures.

5. The assembly as claimed in claim 4, wherein said apertures are star-shaped.

6. The assembly as claimed in claim 2, wherein said surface area surrounding each said aperture is indented in order to receive within the indent said enlarged end portion.

7. The assembly as claimed in claim 3, wherein said surface area surrounding each said aperture is indented in order to receive within the indent said enlarged end portion.

8. The assembly as claimed in claim 4, wherein said surface area surrounding each said aperture is indented in order to receive within the indent said enlarged end portion.

9. The assembly as claimed in claim 6, wherein said enlarged end portion of said hanger is in the shape of a disc and said indented surface area has a perimeter which is circular.

10. The assembly as claimed in claim 6, wherein the enlarged end portion of said hanger is square in cross-section and said indented surface area has a perimeter which is star-shaped.

11. The assembly as claimed in claim 7, wherein the enlarged end portion of said hanger is square in cross-section and said indented surface area has a perimeter which is star-shaped.

12. The assembly as claimed in claim 8, wherein the enlarged end portion of said hanger is square in cross-section and said indented surface area has a perimeter which is star-shaped.
